(19) United States
(12) Patent Application Publication
(10) Pub. No.: US 2013/0062225 A1
(43) Pub. Date: Mar. 14, 2013

(54) ARM PALETTE

(71) Applicants: Barry James LaVaque, Mosinee, WI (US); Korenzander DuBeq, Woodbridge, NJ (US)

(72) Inventors: Barry James LaVaque, Mosinee, WI (US); Korenzander DuBeq, Woodbridge, NJ (US)

(21) Appl. No.: 13/604,836

(22) Filed: Sep. 6, 2012

Related U.S. Application Data
(60) Provisional application No. 61/573,827, filed on Sep. 13, 2011.

(51) Int. Cl. A45D 40/00; B23K 1/00; B23P 11/00

(52) U.S. Cl. 206/1.7; 29/428; 228/101

(57) ABSTRACT

The present invention relates to a palette that is attachable to a user's arm. In one example, the palette facilitates transfer of a product from a container to a work surface by serving as an intermediary surface. By attaching to the arm, the palette provides the user with freedom to use both hands while applying the product.

### CLAIM FOR PRIORITY

This application claims priority under 35 U.S.C. §119(e) to U.S. Provisional Patent Application No. 61/573,827 filed on Sep. 13, 2011, which is hereby incorporated by reference in its entirety.

### TECHNICAL FIELD

The present invention relates to a palette attachable to an arm, where the palette serves as an intermediary for the transfer of products from a container to a working surface.

### BACKGROUND

Artists have used palettes to arrange and mix paints for hundreds of years. More recently, makeup artists have begun using palettes for applying cosmetics. A palette for applying cosmetics can be a surface on which cosmetics are arranged and mixed. The palette can serve as an intermediary for transferring cosmetics, such as makeup, from a container to a person's skin. Palettes are commonly made of stainless steel and held in the user's hand or placed on a counter, and provide a durable work surface to scrape, mash, mix, and blend cosmetics with pressure and speed.

### DESCRIPTION OF DRAWINGS

FIG. 1 is perspective view of an example arm palette.

FIG. 2 is perspective view of an example arm palette.

FIG. 3 is perspective view of an example arm palette.

FIG. 4 is a perspective view of an example surface portion of an arm palette.

FIG. 5 is a perspective view of an example ring portion of an arm palette.

FIG. 6 is a perspective view of an example arm palette attached to a user's forearm.

FIG. 7 is a perspective view of an example arm palette including two magnets.

### DETAILED DESCRIPTION

When applying a beauty product (e.g. cosmetics), an individual may use an applicator to transfer the beauty product directly from a container to their skin. Unfortunately, natural oils from the individual's skin can contaminate the applicator. Reinsertion of the applicator into the container can cause contamination and spoilage of the remaining product. Contaminated products should be discarded, since their performance can diminish, and they may cause adverse skin reactions.

It can be difficult to determine if, and to what degree, a product has been contaminated, since contamination may not be visually apparent and degradation may occur over a period of time. Consequently, identifying which products should be discarded can prove difficult. Replacing discarded beauty products can be costly, so individuals often error on the side of keeping products that should be discarded. To avoid this dilemma, there is a need to improve the application process to prevent contamination of beauty products. In a commercial setting, such as at a beauty salon or department store, this need is even greater, since a product from a single container is often applied to many individuals, which increases the likelihood of contamination.

Using a palette as an intermediary device can prevent contamination of beauty products. The products can be transferred from the container to the palette using a spatula. Applying makeup from a palette, rather than a container, prevents natural oils from contaminating and chemically altering the makeup in the container. Using a palette also prevents cross-contamination between separate containers, thereby extending the life of the cosmetics and ensuring professional-level sanitation.

By using a palette and spatula, the risk of cross-contamination is eliminated, since the applicator is never inserted into the container of cosmetics. Instead, the spatula can be used to transfer cosmetics from the container to the palette before the application process begins. The surface of the palette can then be used to scrape, mash, mix and blend cosmetics with pressure and speed. Once custom blending is achieved, the user can transfer the cosmetics directly from the palette to the skin by using a brush, sponge, puff, or any other suitable disposable applicator. When finished, the palette can be cleaned and sanitized with a cleansing product and tissue or other suitable products or methods that are common in the beauty industry or other service industries.

Prior to the development of the arm palette described herein, it was common for the user to hold a palette in a first hand and hold an applicator in a second hand while applying a product, such as cosmetics, to himself or herself or a client. As a result, the first hand was occupied at all times while holding the palette. This approach left only the second hand available for applying the product or completing other tasks. As a result, additional time was required to apply the product, and the user's ability to multitask was limited.

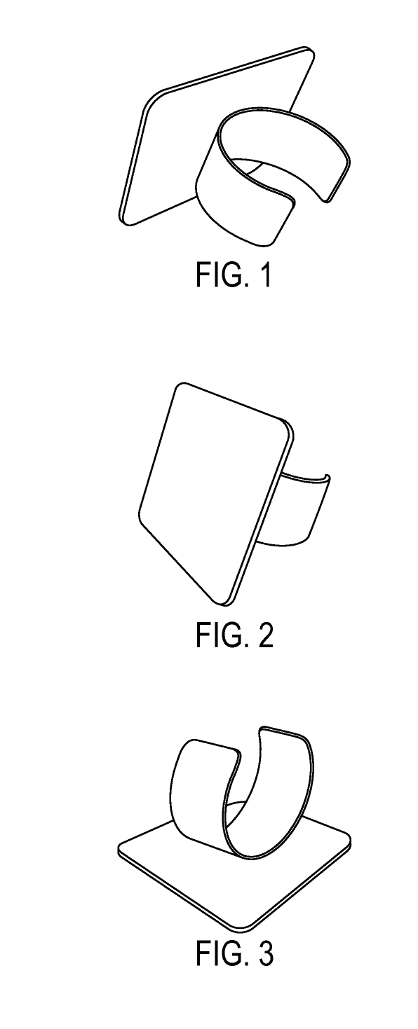

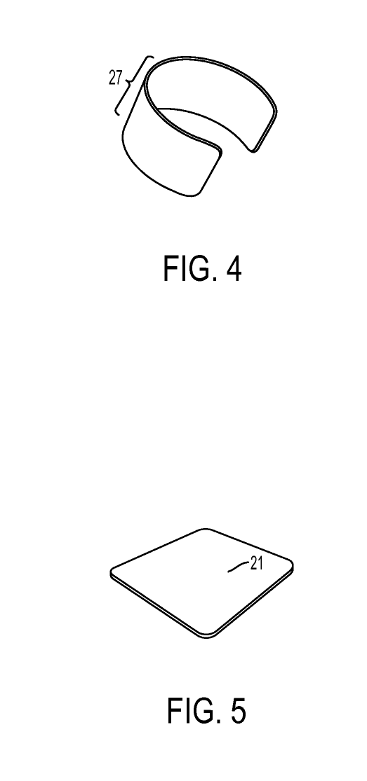

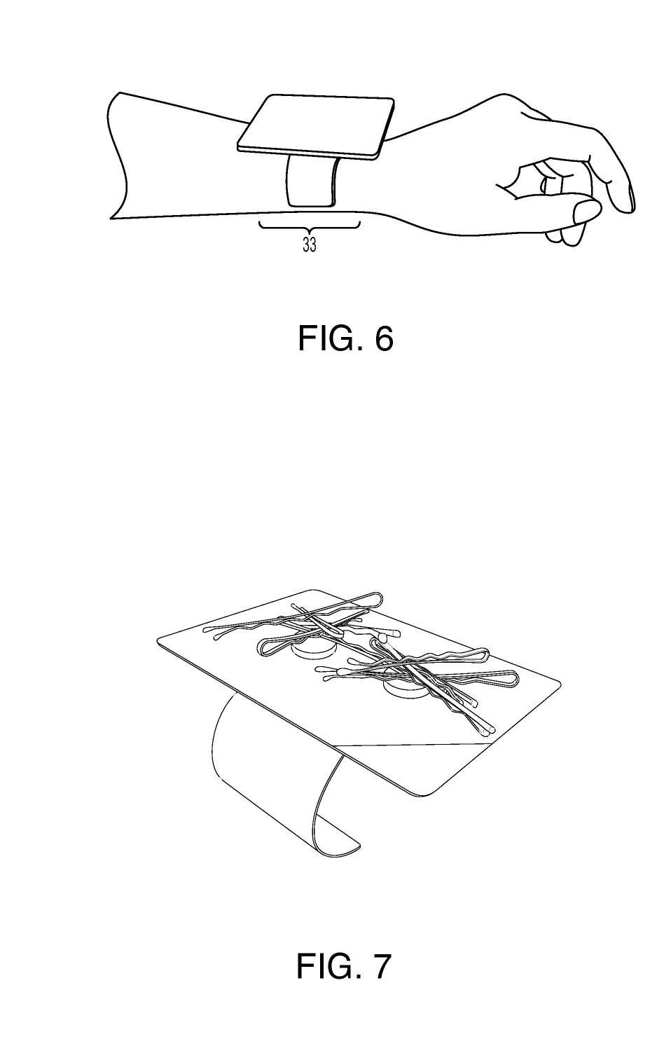

The arm palette described herein allows the user freedom to use both hands when applying a product. This is accomplished by creating a palette that attaches to the user's arm. The palette can attach to any portion of the user's arm (e.g. anywhere from the user's shoulder to wrist), but preferably the arm palette 33 attaches to the user's forearm, as shown in FIG. 6. The arm palette 33 can include a surface portion 21 attached to a band portion 27, as shown in FIGS. 4 and 5, respectively. FIGS. 1-3 show several perspective views of the arm palette 33 having a surface portion 21 and a band portion 27.

The surface portion 21 can be sufficiently rigid to allow the user to scrape, mash, mix or blend cosmetics without the surface portion 21 noticeably deforming. The surface portion 21 can be made of metal, wood, plastic, composite, fabric, nylon, leather, ceramic, or any other suitable material. The arm palette 33 can be reusable or disposable. If the arm palette is reusable, it can be made from a material that is durable and that can be sanitized using conventional methods such as sanitation fluids or autoclaves. In view of these desired attributes, in one example, the surface portion 21 can include stainless steel.

The surface portion 21 can have any suitable shape. For example, the perimeter of the surface portion 21 can be round, square, oval, rectangular, polygonal, or any combination of lines or curves that can be configured to receive and retain products, such as cosmetics. The surface portion 21 can have any suitable size capable of receiving and retaining the product. For example, the surface portion can have dimensions of approximately 8 inches by 4 inches, 8 inches by 3 inches, 8 inches by 2 inches, 7 inches by 3 inches, 7 inches by 2 inches, 6 inches by 4 inches, 6 inches, by 3 inches, 6 inches by 2 inches, 5 inches by 3 inches, 5 inches by 2 inches, 4 inches by 3 inches, 4 inches by 2 inches, 3.5 inches by 2.5 inches, 3 inches by 3 inches, 3 inches by 2 inches, 3 inches by 1 inch, 2 inches by 2 inches, 2 inches by 1 inch, or any other suitable dimensions. Consequently, the surface portion 21 can have a top surface area ranging anywhere from 32 in² to 2 in², such as 32, 24, 21, 18, 16, 15, 14, 12, 10, 9, 8, 6, 4, 3, or 2 in². In one example, the surface portion 21 can extend the entire length of the user's forearm and provide ample surface area to hold several separate mixtures of products. In another example, the surface portion can be much smaller and can provide sufficient surface area for one product or one mixture of products.

The surface portion 21 can have any suitable thickness ranging from, for example, a few thousandths of an inch (i.e. 0.003 inch) to about 0.5 inches, depending on the material selected and the desired weight and rigidity of the surface portion. For example, the surface portion can have a thickness of 1/32 to ¼ inch, 1/32 to 3/16 inch, 1/32 to ⅛ inch, 1/32 to 1/16 inch, 1/16 to ¼ inch, ⅛ to ¼ inch, 3/16 to ¼ inch, or ¼ to 1/2 inch. In one example, the surface portion 21 can be made of stainless steel having a thickness of approximately 1/16 of an inch. The dimensions of the surface portion can be adjusted to accommodate user preferences and various types of products. In one example, the surface portion can provide a rigid work surface to blend cosmetics against.

The surface portion 21 can be flat or curved. A flat surface can be suitable for wet products, whereas a curved surface can be suitable for wet or dry products. Wet products can include, for example, nail polish, paint, or liquid foundation. Dry products can include, for example, powders, such as a powder foundation. In one example, the surface portion 21 can have a concave portion that retains dry products and prevents spillage over outer edges of the surface portion 21. The concave portion can be free of seams or edges that could trap the products and complicate cleaning or sterilization. The concave portion can be curved like an inner surface of a sphere, elliptic paraboloid, or any other suitable surface or shape that tends to retain the cosmetics as the user moves their arm during the application process. In one example, the surface portion can include a combination of flat and concave portions.

The band portion 27 of the arm palette 33 can be made of metal, wood, plastic, fabric, nylon, leather, composite, elastic, ceramic, or any other suitable material. The band portion 27 can have any suitable shape that allows the palette to attach to the user's arm. For example, the band portion can have an inner diameter ranging from about 1.25 inches to about 6.0 inches, depending on the size of the user's arm and the location of attachment on the user's arm. The band portion 27 can be fitted to the user's arm or can be adjustable to fit a variety of arm sizes. For instance, a smaller inner diameter of the band portion 27 can be suitable for attaching to the user's forearm at or near their wrist, as shown in FIG. 6, whereas a larger inner diameter of the band portion 27 can be suitable for attaching to the user's forearm near their elbow or on the user's upper arm.

The band portion 27 can employ any suitable clamping mechanism for attaching the arm palette 33 to the user's arm. For instance, the band portion 27 can be a metallic band, as shown in FIGS. 1-4, 6 and 7, containing a gap to allow for size adjustment. The band portion 27 can be sufficiently flexible to allow a user to adjust the size of the band portion 27 by hand and without the need for special tools. Alternately, the band portion 27 can be made of fabric, elastic, or any other suitable material and not include a gap. In one example, a fabric band can include VELCRO, DUAL LOCK, or any other type of reclosable fastener. The band portion 27 can include a pad on its inner surface to improve comfort against the user's skin. The pad can be formed from any suitable material, such as a fabric, foam, fur, leather, gel, or soft rubber. For reusable arm palettes, the pad can be removable or replaceable. Having a removable pad can allow the surface portion 21 of the palette 33 to be sanitized without damaging the less durable materials of the pad, which may only require gentle cleaning with soap and water. The pad can extend around a circumference of an inner surface of the band portion 27. Alternately, one or more pads can be placed at suitable locations on the inner surface of the band portion to provide suitable comfort to the user. The pad can be attached to the band portion 27 using any suitable fastening method, such as, for example, adhesive, snaps, ties, clips, or VELCRO.

The band portion 27 can be attached to the surface portion 21 using any suitable joining technique. For example, if the band and surface portions are both metallic, then welding, brazing, or other similar joining techniques can be used. In one example, the surface portion 21 can be spot welded to the band portion 27. Alternately, adhesives, fasteners, or ties can be used to join the band portion 27 to the surface portion 21. In another example, the surface portion 21 and band portion 27 can be a formed as a single, integral piece. For instance, the surface and band portions can be molded as a single piece of metal, polymer, or composite.

To use the arm palette 33, the user can attach the palette to their arm. The arm palette 33 can provide the user with a durable working surface to scrape, mash, mix and blend makeup with pressure and speed. Because the arm palette 33 attaches to the user's arm and does not need to be held, both of the user's hands are free to assist in the application of makeup or to complete other activities, such as holding various beauty tools or even holding and using a smartphone or other mobile electronic device. It is common for customers to request that a makeup artist replicate the makeup style of a certain celebrity. So the makeup artist may wish to access a digital photo of that celebrity using a tablet computer to display the photo, which serves as a reference. By having both hands free, the makeup artist can easily access photos on the web without having to set down the palette and without having to worry about spilling cosmetics on the tablet, which can be an expensive device.

Before applying the makeup to a person's skin, the user can use a tool, such as a spatula, to remove the makeup from the container and transfer the makeup to the arm palette 33. The user can then scrape, mash, mix, or blend the makeup against the surface portion 21 of the arm palette 33. Once a desired amount of blending is achieved, the user can then use the arm palette 33 as a work surface for applying makeup directly to a person's skin by using a brush, sponge, puff, or other suitable disposable applicator.

As discussed above, the arm palette 33 can be used by a first person to apply products to their own body, or the arm palette can be used by a first person to apply products to a second person. For instance, a professional makeup artist can attach the arm palette 33 to their arm to aid in applying products to a client. The makeup artist can transfer products from a container to the arm palette 33 using a spatula or other suitable device. If desired, the makeup artist can then add additional products to the arm palette 33 and blend the products on the surface portion 21 before applying them to the user. After the makeup artist has finished applying products to a first client, the arm palette 33 can be deposited into sterilization fluid to sanitize it before it's used with a second client.

The arm palette 33 can be used with any suitable product, such as cosmetics, lotions, paints, finger nail polishes, foods, art supplies, cleaning solvents, solder pastes, lubricants, epoxies, bobby pins, etc. Consequently, the arm palette 33 can be useful in industries beyond the cosmetics industries and for hobbies and other activities. In one example, a nail technician can use the arm palette for finger nail polish. In another example, an artist can use the arm palette for painting. In another example, a baker can use the arm palette for icing used for cake decorating. In another example, an auto repairman can use the arm palette to retain epoxy while repairing a chip in a vehicle's windshield. In another example, an assembly line worker can use the arm palette for solder paste while assembling an electronic device. In these examples, the arm palette serves as a convenient, low-cost, portable working surface. This list of examples is not limiting; other applications for the arm palette are contemplated and will be apparent to those having skill in the art.

In one example, the arm palette 33 can include a magnetized material to allow it to retain small metallic parts, as shown in FIG. 7. For example, the surface portion 21 of the arm palette 33 can include any suitable magnetized material. For instance, the surface portion 21 can itself be magnetized. Alternately, or in addition, a separate magnet can be attached to a top or bottom side of the surface portion 21 to provide a magnetized arm palette. In another example, a magnetized material can be sandwiched between a first surface and a second surface that are combined to form the surface portion 21.

The magnetized material can be used in the field of cosmetics or in other unrelated field. In one example, a watch repairman, while repairing a movement of a watch, can use the arm palette with a magnetized material. As the repairman removes tiny screws from the watch, he can place them on the finger palette to prevent losing them. The arm palette 33 can include an image on the top surface of the surface portion 21. For instance, the arm palette 33 can include an image showing the internals of the watch. The repairman can then position the screws in locations on the arm palette 33 corresponding to where the screws were removed from the watch. This can simplify the reassembly process and ensure that no screws are lost during the disassembly process. The image can be unique for each brand and model of watch. The image can be removable and/or reusable. In another example, the image can be permanent or semi-permanent. For instance, the image can be painted, printed, etched, or laser scribed on the surface portion 21. In another example, the image can be a removable plastic film layer.

Other applications are contemplated. For example, an eye care professional can use an arm palette having a magnetized material to retain small screws while repairing a pair of eyeglasses. In another example, an auto mechanic can use an arm palette having a magnetized material to assist in retrieving a difficult to reach nut or bolt within an engine compartment.

In yet another example, a hairstylist can use an arm palette having a magnetized material to retain a plurality of ferrous bobby pins, as shown in FIG. 7. This arm palette can be used for creating various hairstyles. By selecting a magnetized material with a stronger magnetic field, a greater plurality of bobby pins can be securely retained proximate the surface portion 21 of the arm palette 33. In one example, the magnetized material can include one or more disk shaped magnets located on a top side of the surface portion 21. As a result of this configuration, the bobby pins can be retained at a distance above the surface portion 21, thereby making them easier to grasp by the hairstylist due to the physical clearance between the bobby pins and the top side of the surface portion 21. In one example, the magnet can have a thickness ranging between 0.125 and 1.0 inch, 0.25 and 0.5 inch, or 0.25 and 0.375 inch to make the bobby pins easier to grasp by the hairstylist. In another example, non-magnetic spacers can be inserted between the surface portion 21 and the magnetic material. By using this approach, a slim magnetic material can be used while still providing sufficient clearance between the bobby pins and the top side of the surface portion 21. This approach may reduce the cost of the arm palette 33, since the non-magnetic spacer material may be less expensive than the magnetic material. The non-magnetic spacer material can be connected to the surface portion 21 or magnetic material using any suitable fastening method. As will be apparent to those with skill in the art, an arm palette having a magnetized material can be used for any other suitable application.

Details of one or more embodiments are set forth in the accompanying drawings and description. Other features, objects, and advantages will be apparent from the description, drawings, and claims. Although a number of embodiments of the invention have been described, it will be understood that various modifications can be made without departing from the spirit and scope of the invention. It should also be understood that the appended drawings are not necessarily to scale, presenting a somewhat simplified representation of various features and basic principles of the invention.

What is claimed is:

1. An arm palette, comprising:
a band portion, wherein the band portion is configured to attach to a person's arm; and
a surface portion attached to the band portion, wherein the surface portion is rigid and is configured to receive a product.

2. The arm palette of claim 1, wherein the surface portion comprises a concave portion configured to prevent spillage of the product.

3. The arm palette of claim 1, wherein the surface portion comprises a flat portion.

4. The arm palette of claim 3, wherein the concave portion comprises an inner surface of a sphere or an inner surface of an elliptic paraboloid.

5. The arm palette of claim 1, wherein the band portion has an inner diameter between 1.25 inches and 6.0 inches.

6. The arm palette of claim 1, wherein the surface portion has a top surface area between 2 in² and 32 in² and a thickness between 0.003 and 0.5 in.

7. The arm palette of claim 1, wherein the band portion comprises a reclosable fastener.

9. The arm palette of claim 1, wherein the band portion is adjustable.

10. The arm palette of claim 1, further comprising a pad on an inner surface of the band portion.

11. The arm palette of claim 1, wherein the arm palette comprises a magnetized material.

12. The arm palette of claim 11, wherein the surface portion is configured to receive a plurality of bobby pins adjacent to the magnetized material.

13. A method for manufacturing an arm palette, the method comprising:
attaching a surface portion to a band portion, wherein the band portion is configured to attach to a person's arm, and wherein the surface portion is rigid and is configured to receive a product.

14. The method of claim 13, wherein the surface portion has a top surface area between 2 in² and 32 in².

15. The method of claim 13, wherein attaching the surface portion to the band portion comprises welding or brazing the surface portion to the band portion.

16. The method of claim 13, further comprising attaching a magnet to a top or bottom side surface of the surface portion.

17. An arm palette, comprising:
a band portion, wherein the band portion is configured to attach to a person's arm; and
a surface portion attached to the band portion, wherein the surface portion is rigid, and wherein the surface portion comprises a magnetized material.

18. The arm palette of claim 17, wherein the magnetized material comprises a magnet located on a top side of the surface portion, wherein the magnet is configured to receive and retain ferrous bobby pins.

19. The arm palette of claim 18, wherein the magnet has a thickness of between 0.25 and 0.375 inch.

20. The arm palette of claim 17, wherein the magnetized material comprises a magnet located on a bottom side of the surface portion, and wherein a top side of the surface portion is configured to receive ferrous bobby pins.
